(19) United States
(12) Patent Application Publication
(10) Pub. No.: US 2013/0064415 A1
(43) Pub. Date: Mar. 14, 2013

(54) TEMPLATE CLEANING APPARATUS AND TEMPLATE CLEANING METHOD

(71) Applicant: Takumi OTA, Yokohama-shi (JP)

(72) Inventor: Takumi OTA, Yokohama-shi (JP)

(21) Appl. No.: 13/428,617

(22) Filed: Mar. 23, 2012

(30) Foreign Application Priority Data
Sep. 9, 2011 (JP) 2011-197470

(51) Int. Cl. G06K 9/00

(52) U.S. Cl. 382/100

(57) ABSTRACT

According to one embodiment, there is disclosed a template cleaning apparatus to clean a template for imprint. The template includes a concave-convex pattern and a groove portion, and an image obtaining unit which obtains an image of a region including a side surface of the groove portion of the template. The apparatus further includes a cleaning time determination (CTD) unit having a function to determine cleaning time of the template. The function includes determining the cleaning time by comparing the image obtained by the image obtaining unit with a previously obtained reference image. The apparatus further includes a cleaning unit which cleans the template, based on the cleaning time determined by the CTD unit.

### CROSS-REFERENCE TO RELATED APPLICATIONS

This application is based upon and claims the benefit of priority from prior Japanese Patent Application No. 2011-197470, filed Sep. 9, 2011, the entire contents of which are incorporated herein by reference.

### FIELD

Embodiments described herein relate generally to a template cleaning apparatus and template cleaning method for cleaning a template used for imprint.

### BACKGROUND

In recent years, a pattern forming method using imprint has been remarked. This pattern forming method employs an original plate called a template. On a surface (pattern surface) of the template, there are formed a convex-concave pattern corresponding to a pattern to be formed on a substrate to be processed, and a pattern used for positioning (alignment) between the template and the substrate.

Optical imprint is a kind of imprint which is most expected to be applicable to semiconductor lithography. A pattern forming method using optical imprint includes steps described below.

That is, the method includes a step of applying liquid light curable resin on a surface of the substrate, a step of positioning the surface of the substrate and a surface (pattern surface) of the template, a step of contacting the pattern surface of the template with the liquid light curable resin for a constant time to fill concave portions of the pattern surface with the liquid light curable resin by capillarity, a step of curing the light curable resin by light irradiation, a step of separating the template from the cured light curable resin (resin pattern) (demolding), and a step of etching the substrate using the resin pattern as a mask.

The pattern forming method described above can cause a state that light curable resin (extraneous matter) in a concave-convex pattern on the template after the step of separating the template from the cured light curable resin (a resin pattern). Therefore, the template needs to be cleaned.

However, cleaning of the template with use of a conventional template cleaning apparatus causes problems in view of throughput.

### BRIEF DESCRIPTION OF THE DRAWINGS

FIG. 1 schematically shows an example of a template;

FIG. 2 schematically shows the template to which extraneous matter stick;

FIG. 3 schematically shows a template cleaning apparatus according to an embodiment;

FIG. 4 schematically shows an image obtained by bright-field image observation of an optical microscope;

FIG. 5 schematically shows an image obtained by the dark-field image observation an optical microscope;

FIG. 6 illustrates a state of obtaining an image by atomic force microscope (AFM); and

FIG. 7 is a flowchart for explaining a template cleaning method using the template cleaning apparatus according to an embodiment.

### DETAILED DESCRIPTION

Hereinafter, an embodiment will be described with reference to the drawings.

In general, according to one embodiment, a template cleaning apparatus is disclosed. Here, the template comprises a concave-convex pattern and a groove portion on a surface of thereof. The template cleaning apparatus comprises an image obtaining unit configured to obtain an image of a region including a side surface of the groove portion of the template; and a cleaning time determination unit comprising a function to determine a cleaning time of the template. Here the function includes determining the cleaning time by comparing the image obtained by the image obtaining unit with a reference image previously obtained. The template cleaning apparatus further comprises a cleaning unit configured to clean the template based on the cleaning time determined by the cleaning time determination unit.

According to another embodiment, a template cleaning method is disclosed. Here, the template comprising a concave-convex pattern and a groove portion on a surface of thereof. The template cleaning method comprises obtaining an image of a region including a side surface of the groove portion of the template; and determine a cleaning time of the template by comparing the obtained image with a reference image previously obtained. The template cleaning method further comprises cleaning the template based on the determined cleaning time.

FIG. 1 schematically shows an example of a template 1 to which The present embodiment is applied. The present embodiment will be described supposing that the template 1 is used for optical imprint.

The template 1 comprises a transparent substrate 2, a concave-convex pattern 3 provided on a main surface (a surface opposite to a surface which reflects light) of the transparent substrate 2 and including concave and convex portions, and a groove portion 4 formed around the concave-convex pattern 3.

A main material forming the transparent substrate 2 is, for example, quartz. The concave-convex pattern 3 comprises a pattern (main pattern) corresponding to a device pattern to be formed on a substrate to be processed. The concave-convex pattern 3 further comprises concave and convex portions (not shown) forming an alignment mark.

A depth D1 of the groove portion 4 is greater than a depth D2 of a concave portion of the concave-convex pattern 3 (D1>D2). A lower side of the groove portion 4 is actually not flat but curved. To simplify descriptions, the whole side surface of the groove portion 4 is illustrated as a flat surface.

The groove portion 4 is provided for the purpose of avoiding contact between portions other than concave-convex pattern 3 of the template 1 and a resin pattern already formed on the substrate when the concave-convex pattern 3 of the template 1 is brought into contact with liquid light curable resin applied on the substrate.

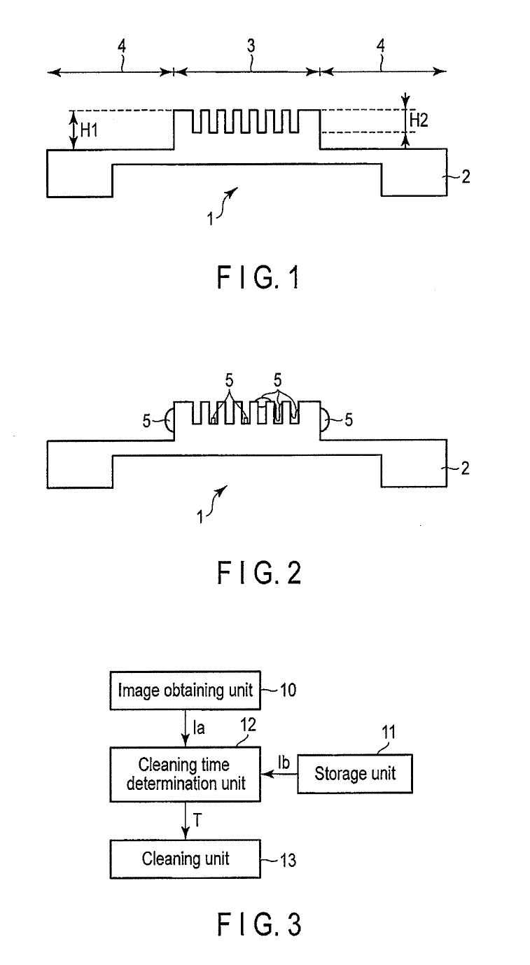

In template cleaning, time is needed to clean extraneous matter (for example, light curable resin). Cleaning time depends on an amount of extraneous matter. As shown in FIG. 2, extraneous matter 5 stick not only to inside of the concave-convex pattern 3 but also to the side surface of the groove portion 4. Particularly viewed from above the main surface, a great amount of extraneous matter 5 stick to the side surface (the side on a boundary side) of a portion corresponding to a boundary between the concave-convex pattern 3 and the groove portion 4. This is because the concave-convex pattern 3 makes contact with the liquid light curable resin. Where a convex portion defined by the main surface (upper surface) of the transparent substrate 2 and the side surface of the groove portion 4 provided aside the main surface is named a mesa portion, a great amount of extraneous matter 5 stick to a side surface of the mesa portion. The extraneous matter 5 are a kind of contamination.

The pattern depth D2 of the template 1 used for manufacturing a semiconductor device reaches several hundred nanometers at most. In contrast, the depth D1 of the groove portion 4 is as large as several ten micrometers. Therefore, a greater amount of extraneous matter 5 stick to the groove portion 4 than to the concave-convex pattern 3. Particularly, a great amount of extraneous matter 5 stick to the side surface of the groove portion 4 (especially the side surface on the boundary side). Therefore, time required for removing the extraneous matter 5 sticking to the side surface of the groove portion 4 is taken as cleaning time.

Conventional cleaning time (α*n*Tref) is decided as follows. The time required for removing extraneous matter in the concave-convex pattern 3 is taken as a cleaning reference time (Tref), then by comparing the depth D1 with the pattern depth D2, the cleaning reference time (Tref) is multiplied by a number (n) (n*Tref) and by further multiplying the resultant (n*Tref) with a safety coefficient (α), thereby the cleaning time (α*n*Tref) is determined.

Conventionally, the amount of extraneous matter is unknown, and therefore, the safety coefficient is evaluated to be considerably great. Therefore, the cleaning time (α*n*Tref) decided as described above is often longer than the time required for removing the extraneous matter sticking to the side surface of the groove portion 4. Further, increase of the cleaning time enhances a risk of damaging the concave-convex pattern 3, and causes a problem of delayed device production and increase of costs.

Therefore, in the present embodiment, the template cleaning is performed using a template cleaning apparatus comprising a configuration as shown in FIG. 3.

The template cleaning apparatus according to The present embodiment comprises:

an image obtaining unit 10 configured to obtain an image of the groove portion 4 of the template 1 shown in FIG. 1;

a storage unit 11 in which a previously obtained reference image Ib is stored;

a cleaning time determination unit 12 having a function to determine cleaning time of the template 1 by comparing an image Ia of the groove portion 4 obtained by the image obtaining unit 10 with the reference image Ib stored in the storage unit 12; and

a cleaning unit 13 for cleaning the template 1, based on cleaning time T determined by the cleaning time determination unit 12.

The template cleaning apparatus according to The present embodiment further comprises a control apparatus not shown. The control apparatus functions as a control center which controls operations of units 10, 11, 12, and 13. The control apparatus comprises a CPU, a storage device, and an input/output device, and is realized by a computer or the like for controlling the units 10, 11, 12, and 13 in a predetermined manner.

The image obtaining unit 10 may obtain a whole image of the groove portion 4 or an image of the side surface of the groove portion 4. However, as described above, a lot of extraneous matter 5 stick to the side surface of the groove portion 4. In general, obtaining of only an image of the side surface is sufficient. From limitation only to an image of the side surface, effects can be expected in that time for obtaining the image can be shortened and that throughput can be improved.

The image obtaining unit 10 comprises, for example, a device which obtains a two-dimensional image of the groove portion 4. For example, a device of this type is an optical microscope. When an optical microscope is used, the image obtaining unit 10 obtains an image (picture) of the groove portion 4, based on a dark-field image observation by optical microscope (observation by optical microscope using a dark-field illumination).

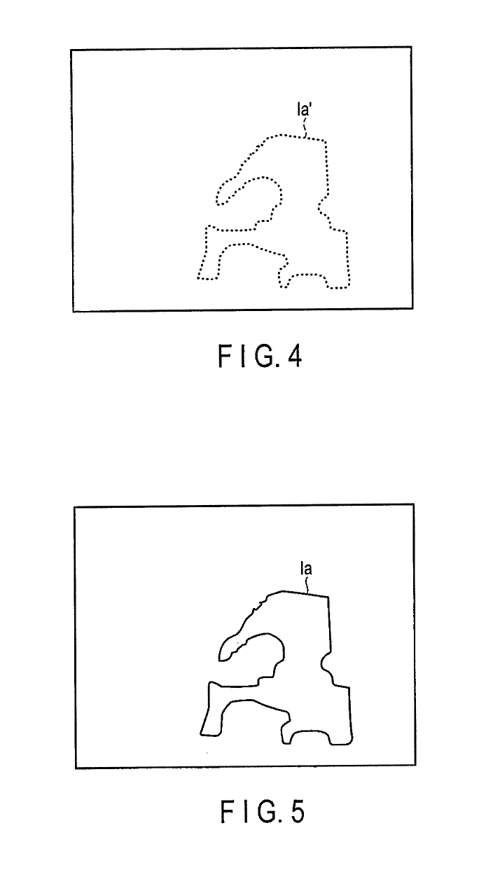

The reason for employing the dark-field image observation is as follows. As shown in FIG. 4, the dark-field image observation results in only the obtaining of image Ia′ having unclear contours. However, eager studies of the present inventor has revealed that an image Ia having clear contours can be obtained by employing the dark-field image observation, as shown in FIG. 5. In FIG. 5, S indicates an area of the image Ia.

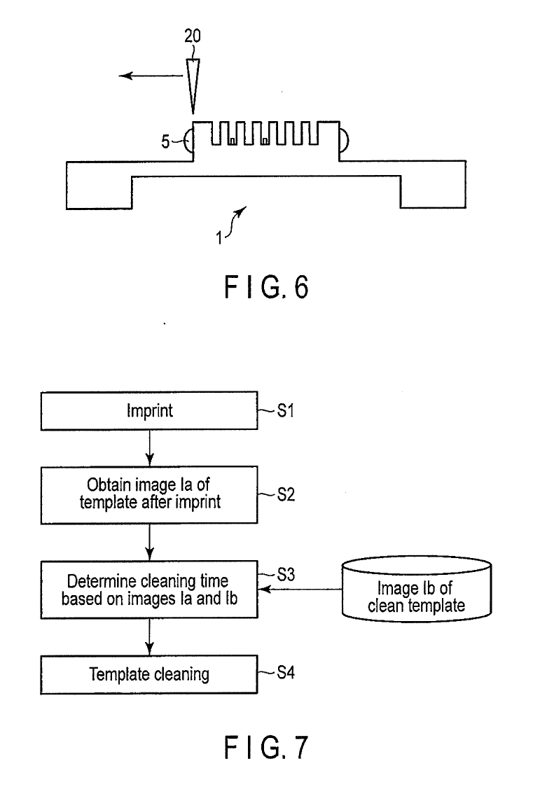

The image obtaining unit 10 may comprise a device which obtains a three-dimensional image of the groove portion 4 in place of a device which obtains a two-dimensional image of the groove portion 4. For example, a device of this type is an atomic force microscope (AFM). FIG. 6 illustrates a state of obtaining an image by AFM. In FIG. 6, reference numeral 20 indicates a cantilever of the AFM. Cantilever 20 is scanned to obtain an image of the extraneous matter 5 on a region including the side surface of the groove portion 4.

The previously obtained reference image Ib is an image of a region including the side surface of the groove portion of a clean template. When an image of the template 1 is obtained by using an optical microscope, an image of a clean template is also obtained by using the optical microscope. Similarly, when an image of the template 1 is obtained by using an AFM, an image of a clean template is also obtained by using the AFM. That is, the mages of the template 1 and the clean template are generally obtained by using the same device.

The clean template has the same shape and size as the template 1 which is the target to be cleaned. The image of the groove portion of the clean template is, for example, the image of the groove portion of the template 1 which has not yet been used for imprint. Further, the image of the groove portion of the clean template may be the image of the template 1 which has already been used for imprint and has been cleaned by cleaning.

The storage unit 11 comprises, for example, a semiconductor memory or a hard disc as a storage device. The reference image Ib stored in the storage device is readable so that the cleaning time determination unit 12 can refer to it.

A template cleaning method using the template cleaning apparatus according to the present embodiment will be described with reference to a flowchart shown in FIG. 7.

[Step S1]

According to a known imprint process, the concave-convex pattern 3 of the template 1 is transferred to light curable resin on the substrate to be processed. Specifically, step S1 comprises a step of applying liquid light curable resin on a surface of the substrate, a step of positioning the surface of the substrate and the surface (concave-convex pattern 3) of the template 1, a step of contacting the surface of the template 1 with the liquid light curable resin for a constant time to fill concave portions of the concave-convex pattern 3 with the liquid light curable resin by capillarity, a step of curing the light curable resin by light irradiation, and a step of separating the template 1 from the cured light curable resin (resin pattern) (demolding). In the present embodiment, the separated template 1 is cleaned. In the imprint process, etching the substrate by using the resin pattern as a mask subsequent is followed by the demolding.

[Step S2]

The image (obtained image) Ia of the region including the side surface of the groove portion 4 of the template 1 after the demolding is obtained.

[Step S3]

The reference image Ib stored in the storage unit 11 of FIG. 3 is read out, and the cleaning time determination unit 12 determines cleaning time by comparing the obtained image Ia with the reference image Ib. Hereinafter, a determination method for determining the cleaning time will further be described.

The amount of extraneous matter on the side surface of the groove portion 4 of the template 1 can be estimated by comparing the obtained image Ia with the reference image Ib. When the image is obtained by the optical microscope, for example, a positive correlation may exists between the area S of the image Ia shown in FIG. 5 and the amount of extraneous matter. That is, the greater the area S, the greater the amount of extraneous matter.

Therefore, a calculating formula for estimating the amount of extraneous matter from an area S1 is previously obtained by simulation or actual measurement. A program corresponding to the obtained calculating formula is incorporated in the cleaning time determination unit 12. Further, a program for estimating the area S from the image Ia obtained by the image obtaining unit 10 is incorporated in the cleaning time determination unit 12.

In this manner, the area S is estimated from the image Ia obtained by the image obtaining unit 10, and the amount of extraneous matter is estimated from the estimated area S1.

Similarly, it is considered that a positive correlation exists between the amount of extraneous matter and the cleaning time. That is, the greater the amount of extraneous matter, the longer the cleaning time.

Therefore, a calculating formula for estimating the amount of extraneous matter from the cleaning time is previously obtained by simulation or actual measurement. A program corresponding to the obtained calculating formula is incorporated in the cleaning time determination unit 12.

In this manner, the cleaning time can be estimated from the estimated amount of extraneous matter described above, i.e., the cleaning time can be determined.

In place of the calculating formula to estimate the amount of extraneous matter from the area S1, a table expressing correspondence between the area S1 and the amount of extraneous matter may be incorporated in the cleaning time determination unit 12. For each of areas which are not cited in the table, for example, an amount of extraneous matter corresponding to the closest area in the table is selected.

Similarly, a table expressing correspondence between the image Ia and the area S and a table expressing a relationship between the amount of extraneous matter and the cleaning time may be incorporated in the cleaning time determination unit 12.

When an image is selected by an AFM, cleaning time is decided in the same manner as described above.

[Step S4]

The cleaning time T determined by the cleaning time determination unit 12 in FIG. 3 is send to the cleaning unit 13. Based on the cleaning time T, the cleaning unit 13 cleans the template 1. The cleaning time for the template 1 by the cleaning unit 13 is not always equal to the cleaning time T. For example, when cleaning for the template 1 is found to be insufficient by inspecting the template 1 after cleaning the template 1 by the cleaning unit 13, there is a possibility that cleaning time for the cleaning unit 13 is set to be longer than the cleaning time T.

In place of reflecting the inspection result onto the cleaning unit 13, the inspection result may be reflected onto the cleaning time determination unit 12. In this case, the cleaning time for the cleaning unit 13 is equal to T.

As has been described above, in the present embodiment, the cleaning time T is determined, based on the amount of extraneous matter on the side surface of the groove portion 4 of the template 1. Conventionally, the cleaning time (α*n*Tref) is estimated from the amount of extraneous matter 5 on the concave-convex pattern 3. Therefore, according to the present embodiment, cleaning time required for removing the extraneous matter of the groove portion 4 can be determined more accurately than the conventional way. In this manner, increase of cleaning time and decrease of throughput can be suppressed. Since increase of cleaning time can be suppressed, increase of a risk of damaging the concave-convex pattern 3, delayed device production, and increase of costs can be suppressed.

As described above, the cleaning time determination unit 12 of the present embodiment includes a function (first function) to decide cleaning time by comparing the obtained image Ia and the reference image Ib, and may further include a function (second function) described below.

That is, the second function is configured to determine the cleaning time for the template 1 without comparing the obtained image Ia with the reference image Ib, when the cleaning time determination unit 12 has determined the cleaning time T for the template 1 one or more times, by comparing the obtained image Ia with the reference image Ib,

The second function determines the cleaning time of the template 1, based on one or a plurality of parameters which define process conditions for the imprint (step S1) performed with use of the template 1.

More specifically, the second function generates a formula including the one or plurality of parameters in order to determine the cleaning time corresponding to the cleaning time T determined by comparing the obtained image Ia with the reference image Ib, and the second function determines the cleaning time corresponding to the cleaning time T based on the generated formula.

The one or plurality of parameters includes, for example, at least one of: the number times of applications of light curable resin (shot number of light curable resin), which is needed for applying light curable resin on a plurality of regions on a substrate to be processed by repeating application (shot) of light curable resin by inkjet method; time for contacting the substrate with the template in order to fill the concave portions of the concave-convex pattern of the template with the light curable resin applied on the substrate (filling time of light curable resin); and time for irradiating light onto the curable resin through the template in order to cure the light curable resin after the filling time has passed. In general, the greater the shot number, the longer the cleaning time. Similarly, the longer the filling time, the longer the cleaning time, and the longer the light irradiation time, the longer the cleaning time. In consideration of such a tendency as described above, for example, the foregoing formula is generated, based on a method of APC (Advanced Parameter Control).

Although the foregoing embodiment has been described with reference to the template cleaning apparatus in case of optical imprint, the invention is also applicable to the template cleaning apparatus in case of imprint of any other type including thermal imprint.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template cleaning apparatus configured to clean a template for imprint, the template comprising a concave-convex pattern and a groove portion on a surface of thereof, the apparatus comprising:
an image obtaining unit configured to obtain an image of a region including a side surface of the groove portion of the template;
a cleaning time determination unit comprising a function to determine a cleaning time of the template, the function including determining the cleaning time by comparing the image obtained by the image obtaining unit with a reference image previously obtained; and
a cleaning unit configured to clean the template based on the cleaning time determined by the cleaning time determination unit.

2. The apparatus according to claim 1, wherein the groove portion is formed around the concave-convex pattern and has a greater depth than a depth of the concave-convex pattern.

3. The apparatus according to claim 1, wherein the reference image previously obtained is an image of the groove portion of a clean template.

4. The apparatus according to claim 1, wherein the image obtaining unit obtains an image of extraneous matter on the side surface of the groove portion.

5. The apparatus according to claim 4, wherein the image obtaining unit comprises an optical microscope.

6. The apparatus according to claim 5, wherein the image obtaining unit is configured to obtain the image of the extraneous matter on the groove portion based on a dark-field image observation by the optical microscope.

7. The apparatus according to claim 4, wherein the image obtaining unit comprises an atomic force microscope.

8. The apparatus according to claim 1, wherein the cleaning time determination unit further comprises a function to determine the cleaning time without comparing the obtained image with the reference image after the cleaning time is determined at least one time by comparing the obtained image with the reference image.

9. The apparatus according to claim 8, wherein the function to determine the cleaning time of the template without comparing the obtained image with the reference image comprises determining a cleaning time of the template based on one or plurality of parameters defining process conditions of a imprint performed by using the template.

10. The apparatus according to claim 9, wherein the function to determine the cleaning time of the template without comparing the obtained image with the reference image comprises generating a formula including the one or plurality of parameters in order to determine a cleaning time corresponding to the cleaning time determined by comparing the obtained image with the reference image.

11. The apparatus according to claim 10, wherein the one or plurality of parameters comprise at least one of shot number of a light curable resin, filling time of the light curable resin, and the light irradiation time, when the imprint is optical imprint.

12. A template cleaning method configured to clean a template for imprint, the template comprising a concave-convex pattern and a groove portion on a surface of thereof, the method comprising:
obtaining an image of a region including a side surface of the groove portion of the template;
determine a cleaning time of the template by comparing the obtained image with a reference image previously obtained; and
cleaning the template based on the determined cleaning time.

13. The method according to claim 12, wherein the groove portion is formed around the concave-convex pattern and has a greater depth than a depth of the concave-convex pattern.

14. The method according to claim 12, wherein the reference image previously obtained is an image of the groove portion of a clean template.

15. The method according to claim 12, wherein the obtaining the image comprises obtaining an image of extraneous matter on the side surface of the groove portion.

16. The method according to claim 15, wherein the obtaining the image is performed by using an optical microscope.

17. The method according to claim 16, wherein the obtaining the image is configured to obtain the image of the extraneous matter on the groove portion based on a dark-field image observation by the optical microscope.

18. The method according to claim 15, wherein the obtaining the image is performed by using an atomic force microscope.

19. The method according to claim 12, wherein the determining the cleaning time further comprises determining the cleaning time without comparing the obtained image with the reference image after the cleaning time is determined at least one time by comparing the obtained image with the reference image.

20. The method according to claim 19, wherein the determining the cleaning time of the template without comparing the obtained image with the reference image comprises determining a cleaning time of the template based on one or plurality of parameters defining process conditions of a imprint performed by using the template.
